(19) United States
(12) Patent Application Publication
(10) Pub. No.: US 2017/0371124 A1
(43) Pub. Date: Dec. 28, 2017

(54) IMAGING APPARATUS AND ELECTRONIC DEVICE

(71) Applicant: SONY CORPORATION, TOKYO (JP)

(72) Inventors: KIYOTAKA HORI, KUMAMOTO (JP); TETSUYA NAKAZONO, KUMAMOTO (JP); KIYOYUKI ATA, KUMAMOTO (JP); MASAFUMI OKANO, KANAGAWA (JP)

(21) Appl. No.: 15/542,742

(22) PCT Filed: Jan. 15, 2016
(86) PCT No.: PCT/JP2016/051074

§ 371 Date: Jul. 11, 2017

(30) Foreign Application Priority Data
Jan. 29, 2015 (JP) 2015-015537

(51) Int. Cl. G02B 7/02; H01L 27/14; H04N 5/369; G02B 5/00

(52) U.S. Cl. CPC G02B 7/02; H04N 5/369; H01L 27/14; G02B 5/00

(57) ABSTRACT

The present technology relates to an imaging apparatus and an electronic device each capable of reducing or eliminating occurrence of ghost and flare in the imaging apparatus. In an imaging apparatus including a substrate having an imaging device mounted thereon, a frame fixed on the substrate, and a seal glass, wherein the seal glass and the frame are bonded together using a sealing resin to provide a structure that encapsulates the imaging device, a cured material resulting from curing of the sealing resin has a regular reflectance of 3% or less, and a diffuse reflectance of 30% or less. This can reduce or eliminate occurrence of ghost and flare in the imaging apparatus.

### TECHNICAL FIELD

The present technology relates to an imaging apparatus and to an electronic device, and more particularly, to an imaging apparatus and to an electronic device each capable of reducing or eliminating occurrence of ghost, flare, and the like.

### BACKGROUND ART

In recent years, in the field of digital video camera and digital still camera, size reduction has been pursued for a device featuring high resolving power that provides imaging of an object in great detail, as well as high portability. Moreover, in the field of imaging apparatus, development efforts have been directed at reduction in pixel size, with maintenance of imaging characteristics.

Furthermore, in recent years, in addition to the continuing demand for a higher resolution and a smaller size, there have been increasing demands for improvement of minimum illuminance level, for high-speed imaging, and the like. Thus, an imaging apparatus is expected to have totally higher image quality, including a signal-to-noise ratio, for meeting such demands. Patent Document 1 proposes that a light blocking film formed on a pixel boundary of a light-receiving surface with an insulation layer interposed therebetween be formed, to reduce optical color mixing and occurrence of flare in an attempt to improve image quality.

Patent Document 2 proposes that inclusion of a substrate, a solid-state imaging device formed on the substrate, a frame unit formed on the substrate in an outer peripheral region of the solid-state imaging device, the frame unit having a black surface and being formed of a metal-based material, and a seal plate having light permeability, formed on the frame unit, to encapsulate the solid-state imaging device together with the frame unit, can increase the height of a frame to which a protective member having light permeability and providing space above the solid-state imaging device is bonded, and can reduce or eliminate light reflection at a side surface of the frame.

### CITATION LIST

### Patent Document

Patent Document 1: Japanese Patent Application Laid-Open No. 2010-186818

Patent Document 2: Japanese Patent Application Laid-Open No. 2009-302102

### SUMMARY OF THE INVENTION

### Problems to be Solved by the Invention

An imaging apparatus is desired to reduce or eliminate occurrence of flare and ghost to further improve image quality. An imaging apparatus having a hollow structure formed therein may cause a stray light component to be generated in the hollow portion, resulting in flare and/or ghost. Patent Documents 1 and 2 propose no countermeasures against such stray light component.

It is desired that such stray light component not be generated, and that occurrence of flare and ghost be reduced or eliminated.

The present technology has been made in view of the foregoing situation, and is directed to achieving reduction or elimination of occurrence of flare and ghost, and to thus improving image quality.

### Solutions to Problems

An imaging apparatus according to one aspect of the present technology includes a substrate having an imaging device mounted thereon; a frame fixed on the substrate; and a seal glass, in which the seal glass and the frame are bonded together using a sealing resin to provide a structure that encapsulates the imaging device.

A cured material resulting from curing of the sealing resin may have a regular reflectance of 3% or less.

A cured material resulting from curing of the sealing resin may have a diffuse reflectance of 30% or less.

A cured material resulting from curing of the sealing resin may have a diffuse reflectance of 10% or less.

A cured material resulting from curing of the sealing resin may have a surface roughness of 0.5 um or more.

The sealing resin that bonds together the seal glass and the frame may have a composition including a flat filler and a particulate filler.

The flat filler may be formed of one or a combination of talc, mica, and boron nitride (BN).

The flat filler may have an average particle size in a range of from 0.1 to 100 um.

The flat filler may have an average particle size in a range of from 1 to 10 um.

The particulate filler may be formed of one or a combination of silica (SiO₂), alumina (Al₂O₃), aluminum nitride (AlN), titanium oxide (TiO₂), barium titanate (BaTiO₃), zirconia (ZrO₂), zinc oxide (ZnO), ITO, yttrium oxide (Y₂O₃), cerium oxide (CeO₂), tin oxide (SnO₂), and copper oxide (CuO).

The particulate filler may have an average particle size in a range of from 0.001 to 1 um.

The particulate filler may have an average particle size in a range of from 0.01 to 0.1 um.

The sealing resin may be a thermosetting resin.

The sealing resin may be a UV-curable resin.

The sealing resin may contain a coloring agent.

The sealing resin may contain a coloring agent that absorbs visible light.

The sealing resin may contain carbon black as the coloring agent.

The imaging apparatus further includes a unit including a lens, on the frame.

An electronic device according to one aspect of the present technology includes an imaging apparatus including a substrate having an imaging device mounted thereon, a frame fixed on the substrate, and a seal glass, in which the seal glass and the frame are bonded together using a sealing resin to provide a structure that encapsulates the imaging device, and a signal processing unit configured to perform signal processing on a signal output from the imaging apparatus.

An imaging apparatus according to one aspect of the present technology includes a substrate having an imaging device mounted thereon, a frame fixed on the substrate, and a seal glass. The seal glass and the frame are bonded together using a sealing resin to provide a structure that encapsulates the imaging device.

An electronic device according to one aspect of the present technology is configured to include the imaging apparatus, and processes a signal from the imaging apparatus.

Effects of the Invention

According to one aspect of the present technology, occurrence of flare and ghost can be reduced or eliminated, and image quality can thus be improved.

Note that the effects described above are not limiting, and may be any of the effects described in the present disclosure.

### BRIEF DESCRIPTION OF DRAWINGS

FIG. 1 is a diagram illustrating a configuration of an imaging apparatus.

FIG. 2 is a diagram for illustrating a stray light component.

FIG. 3 is a figure for illustrating compositions of sealing resins.

FIG. 4 is a diagram for illustrating an electronic device.

FIG. 5 is a diagram for illustrating example applications.

### MODE FOR CARRYING OUT THE INVENTION

A mode (hereinafter referred to as “embodiment”) for practicing the present technology will be described below. The description is provided in the order set forth below:
1. Configuration of imaging apparatus,
2. Detail of stray light component,
3. Detail of composition of sealing resin,
4. Configuration of electronic device, and
5. Example application of imaging apparatus.

### Configuration of Imaging Apparatus

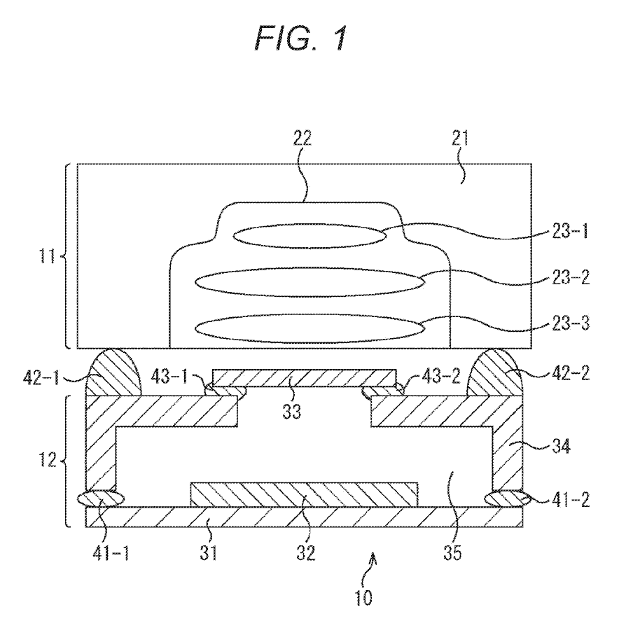

The present technology is applicable to an imaging apparatus including an imaging device. FIG. 1 is a cross-sectional view illustrating a configuration of an imaging apparatus. An imaging apparatus 10 shown in FIG. 1 includes an upper unit 11 and a lower unit 12. For purposes of illustration, the imaging apparatus 10 is described herein as consisting of the upper unit 11 and the lower unit 12.

The upper unit 11 includes an actuator 21, a lens barrel 22, and lenses 23. The lower unit 12 includes a substrate 31, an imaging device 32, a seal glass 33, and a frame 34.

Three lenses, i.e., lenses 23-1, 23-2, and 23-3, are incorporated in the lens barrel 22. The lens barrel 22 is configured to hold these lenses 23-1 to 23-3. The lens barrel 22 is included within the actuator 21, and the actuator 21 is mounted on top of the lower unit 12. Note that the description will be continued using the example in which the three lenses are incorporated in the lens barrel 22, but other number of lenses, for example, more than three lenses, may be incorporated.

For example, an outer side surface of the lens barrel 22 has a thread (not shown) thereon, and a portion of inside of the actuator 21 has a thread (not shown) at a position that will provide threaded engagement with the thread of the lens barrel 22. Thus, the thread of the lens barrel 22 and the thread inside the actuator 21 are configured to be threadedly engaged with each other.

If the lens barrel 22 is configured to be movable in vertical directions as viewed in the figure to provide a configuration that allows autofocusing (AF), a coil is provided on a side surface of the lens barrel 22 (a lens holder having the lens barrel 22 attached thereon), for example. In addition, a magnet is provided in the actuator 21 at a position facing the coil. The magnet includes a yoke, and the coil, the magnet, and the yoke together form a voice coil motor.

A current flowing through the coil generates force in a vertical direction as viewed in the figure. The generated force causes the lens barrel 22 to move in the upward or downward direction. The movement of the lens barrel 22 changes the distance between the lenses 23-1 to 23-3 held by the lens barrel 22 and the imaging device 32. Such mechanism enables autofocusing to be provided.

Note that the description will be continued on the assumption that the upper unit 11 includes the actuator 21, but a configuration may also be possible in which the upper unit 11 does not include the actuator 21. The upper unit 11 is a portion known as lens unit or the like.

An imaging device 32 is provided in a center portion of the lower unit 12. The imaging device 32 is mounted on the substrate 31, and is connected to the substrate 31 using a wire (not shown). The substrate 31 is a portion known as interposer or the like. The frame 34 is mounted on a plane on which the imaging device 32 of the substrate 31 is provided. The frame 34 has a function to hold the seal glass 33. In addition, the upper unit 11 is provided on an opposite side of the frame 34 away from the substrate 31.

To prevent foreign matter, such as dust, from entering a void 35 enclosed by the substrate 31, by the seal glass 33, and by the frame 34, the substrate 31, the seal glass 33, and the frame 34 are bonded together without creating interspace and the like therebetween. The void 35 is a generally enclosed space made by the substrate 31, the seal glass 33, and the frame 34.

This forms a configuration in which no foreign matter may enter the void 35. The seal glass 33 is used also for encapsulating the imaging device 32 within the void 35. The seal glass 33 may be an infrared cut filter (IRCF) having a function to cut off an infrared radiation.

During manufacture of the imaging apparatus 10, the frame 34 is joined to the substrate 31 by a sealing resin 41-1 and a sealing resin 41-2. The frame 34 is in contact with the substrate 31 on an area having a predetermined shape, for example, a continuous shape, such as a quadrangle, and the sealing resin 41 is applied on the area having that continuous shape. Thus, as shown in FIG. 1, although the sealing resin 41-1 and the sealing resin 41-2 are illustrated as separate sealing resins in the cross-sectional view, the sealing resin 41-1 and the sealing resin 41-2 form one looped adhesive layer, and are thus continuously applied on the area where the frame 34 is in contact with the substrate 31.

Similarly, the frame 34 and the upper unit 11 are joined to each other by a sealing resin 42-1 and a sealing resin 42-2.

The seal glass 33 is joined to the frame 34 by a sealing resin 43-1 and a sealing resin 43-2. The sealing resin 43 is applied to join the seal glass 33 to the frame 34.

Thus, the imaging apparatus 10 has a hollow structure having the void 35 enclosed by the substrate 31, the seal glass 33, and the frame 34. A hollow structure may generate a stray light component. This stray light component will now be described.

Note that the description will be provided, as an example, in terms of the imaging apparatus 10 having a hollow structure. However, even if the imaging apparatus 10 has no hollow structures, application of the present technology described below can reduce or eliminate occurrence of a stray light component as long as the imaging apparatus may generate a stray light component described below. In addition, application of the present technology described below can reduce or eliminate occurrence of a stray light component also in an imaging apparatus having a hollow structure filled with a predetermined material.

### Detail of Stray Light Component

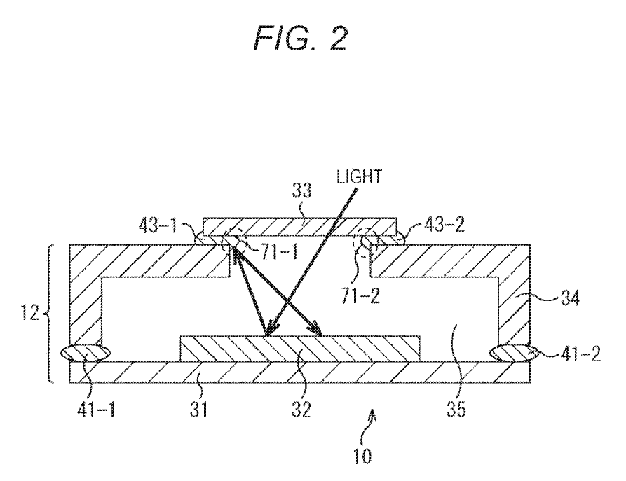

FIG. 2 is a diagram for illustrating a stray light component, and is a diagram illustrating the lower unit 12 portion of the imaging apparatus 10 of FIG. 1. The arrows in the figure each indicate a light propagation direction.

Light incident upon the lower unit 12 through the lenses 23 (FIG. 1) is received by the imaging device 32 through the seal glass 33. Some amount of the light incident through the seal glass 33 is reflected by the imaging device 32.

A proportion of the light reflected by the imaging device 32 reaches a portion called fillet 71-1 of the sealing resin 43 as shown in FIG. 2, and is further reflected to be again incident upon the imaging device 32. FIG. 2 illustrates a path of light reflected at the fillet 71-1, but light reflected at a fillet 71-2 may also be similarly incident upon the imaging device 32.

As described above, when the light reflected by the imaging device 32 and by the fillet 71 is incident upon, and received by, the imaging device 32, flare and/or ghost occur, causing a reduction in image quality. Accordingly, it is desired that such stray light component be removed to reduce or eliminate occurrence of flare and ghost.

Thus, an improvement is made so that light incident upon the fillet 71 will be prevented from being reflected. Herein, by forming the sealing resin 43 from the materials as described below, light reflection at the fillet 71 is reduced.

### Detail of Composition of Sealing Resin

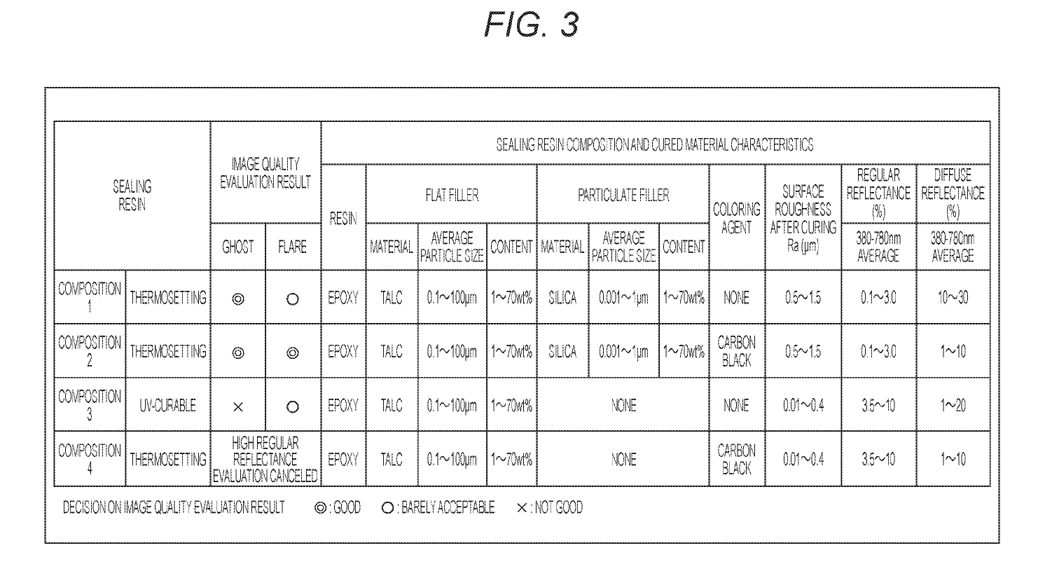

FIG. 3 is a figure for illustrating materials of the sealing resin 43. The table shown in FIG. 3 has fields such as “Sealing Resin,” “Image Quality Evaluation Result,” and “Sealing Resin Composition and Cure Characteristics.”

In addition, the field “Image Quality Evaluation Result” includes “Ghost” and “Flare” fields. The applicant has evaluated levels of ghost and flare using the sealing resin 43 having different compositions. The evaluation results are shown in these fields.

In addition, the field “Sealing Resin Composition and Cure Characteristics” includes “Resin,” “Flat Filler,” “Particulate Filler,” “Coloring Agent,” “Surface Roughness After Curing,” “Regular Reflectance,” and “Diffuse Reflectance” fields.

Furthermore, the fields “Flat Filler” and “Particulate Filler” each include “Material,” “Average Particle Size,” and “Content” fields.

FIG. 3 shows evaluation results of four types of the sealing resin 43 respectively having composition 1, composition 2, composition 3, and composition 4. These results will now be referenced in order starting from composition 1.

“Sealing Resin” of composition 1 is “thermosetting,” and “Ghost” of “Image Quality Evaluation Result” reads “good,” and “Flare” reads “barely acceptable.” That is, it can be seen that forming the sealing resin 43 using composition 1 reduces occurrence of both ghost and flare. Composition 1 is a composition described as follows.

“Resin” contained in composition 1 is “epoxy.” In addition, “Flat Filler” contained in composition 1 is “talc” in terms of “Material,” and has “Average Particle Size” of “0.1-100 um,” and “Content” of “1-70 wt %.” Composition 1 of the sealing resin 43 contains not only a flat filler, but also a particulate filler. “Particulate Filler” contained in composition 1 is “silica” in terms of “Material,” and has “Average Particle Size” of “0.001-1 um,” and “Content” of “1-70 wt %.”

Composition 1 does not contain “Coloring Agent.” “Surface Roughness After Curing” of the sealing resin 43 containing the flat filler and particulate filler having these characteristics is “0.5-1.5 um.” It should be noted that “Surface Roughness After Curing” as used herein is an “arithmetic average roughness Ra.”

“Regular Reflectance” is “0.1-3.0% , ” and “Diffuse Reflectance” is “10-30%.” It should be noted that “Regular Reflectance” as used herein is also referred to as “specular reflectance,” and is an “average value in a range of 380 to 780 nm” of a relative value with respect to a value of an aluminum reference mirror defined as 100%; and “Diffuse Reflectance” is an “average value in a range of 380 to 780 nm” of a relative value with respect to a value of a white board of barium sulfate defined as 100%.

Composition 2 has a same composition as the composition of composition 1 except that composition 2 contains “carbon black” as “Coloring Agent.” It can be seen that inclusion of the coloring agent in the sealing resin 43 improves “Flare” to be “good.” That is, it is shown that forming the sealing resin 43 using composition 2 reduces the levels of both “Ghost” and “Flare.”

It can be inferred that inclusion of carbon black in the sealing resin 43 as a coloring agent reduces “Diffuse Reflectance” to “1-10%, ” allowing occurrence of “Flare” to be reduced.

For comparison with compositions 1 and 2, evaluation was also carried out on compositions 3 and 4. The compositions 3 and 4 each contain a flat filler in the sealing resin 43, but do not contain a particulate filler.

Composition 3 is “UV-curable,” contains “Flat Filler” which is “talc” having “Average Particle Size” of “0.1-100 um” similarly to compositions 1 and 2, and does not contain “Particulate Filler” as indicated as “none.” In addition, composition 3 neither contains “Coloring Agent.” Forming the sealing resin 43 using this composition 3 resulted in “Ghost” at a level of “not good,” and “Flare” at a level of “barely acceptable.”

Composition 4 is “thermosetting,” contains “Flat Filler” which is “talc” having “Average Particle Size” of “0.1-100 um” similarly to compositions 1 and 2, and does not contain “Particulate Filler” as indicated as “none.” In addition, composition 4 contains “carbon black” as “Coloring Agent.” Forming the sealing resin 43 using this composition 4 resulted in a high regular reflectance, and evaluation of “Ghost” and “Flare” was therefore canceled.

These results show that configuring the sealing resin 43 to contain a flat filler and a particulate filler such as compositions 1 and 2 can reduce or eliminate occurrence of ghost and flare. Moreover, it is shown that a flat filler and a particulate filler each having a particle size, and contained with a content, such as those shown in FIG. 3 can reduce or eliminate occurrence of ghost and flare.

In addition, it is shown that a combination of a flat filler and a particulate filler that exhibits a regular reflectance within a range of from 0.1 to 3.0 (%) (3% or less) can reduce or eliminate occurrence of ghost and flare. Moreover, it is also shown that a combination of a flat filler and a particulate filler that exhibits a diffuse reflectance within a range of from 1 to 30 (%) (30% or less) can reduce or eliminate occurrence of ghost and flare. A diffuse reflectance of 10% or less further permits a satisfactory reduction of flare, and therefore a composition that achieves a diffuse reflectance of 10% or less is desirable.

It is also shown that inclusion a coloring agent in the sealing resin 43 can further reduce or eliminate occurrence of ghost and flare.

Note that the case shown in FIG. 3 is merely an example, and is not intended to be limiting. For example, in addition to the example described above, any of the fillers described below may also be used.

The flat filler may be talc, mica, boron nitride (BN), or the like. In addition, these flat fillers may be used alone or in combination of two or more. Moreover, a flat filler is used having an average particle size of from about 0.1 to 100 um, and desirably within a range of from 1 to 10 um.

The particulate filler may be silica (SiO₂), alumina (Al₂O₃), aluminum nitride (AlN), titanium oxide (TiO₂), barium titanate (BaTiO₃), zirconia (ZrO₂), zinc oxide (ZnO), ITO, yttrium oxide (Y₂O₃), cerium oxide (CeO₂), tin oxide (SnO₂), copper oxide (CuO), or the like. In addition, these particulate fillers may be used alone or in combination of two or more. Moreover, a particulate filler is used having an average particle size of from about 0.001 to 1 um, and desirably within a range of from 0.01 to 0.1 um.

Furthermore, the sealing resin 43 having composition 2 described above is described as including carbon black as the coloring agent by way of example, but other coloring agent may also be used. For example, a coloring agent that absorbs visible light may be included as a constituent.

Furthermore, the sealing resins 43 having compositions 1 and 2 described above are each described as a thermosetting resin by way of example, but may also be a UV-curable resin. In addition, the sealing resin 43 having compositions 1 and 2 described above are each described as including epoxy resin as the resin by way of example, but other resin may also be used.

High surface roughness of the sealing resin 43 after being cured results in a reduced regular reflectance. Therefore, use of a combination of a flat filler and a particulate filler that exhibits a surface roughness (Ra) of 0.5 um or more enables occurrence of ghost and flare to be reduced or eliminated.

Note that the embodiment described above has been described in terms of the sealing resin 43 that bonds the seal glass 33 to the frame 34 as an example, but the sealing resins 41 and 42 may also have the same composition as the composition of the sealing resin 43.

According to the present technology, occurrence of ghost and flare can be reduced or eliminated, and image quality can thus be improved as described above.

### Configuration of Electronic Device

The imaging apparatus described above is applicable to an entire range of electronic devices that use an imaging device in an image capturing unit (photoelectric conversion unit), such as an imaging apparatus including a digital still camera and a video camera; a mobile terminal device having an imaging function, including a mobile phone terminal; and a copier using an imaging apparatus in an image scanning unit.

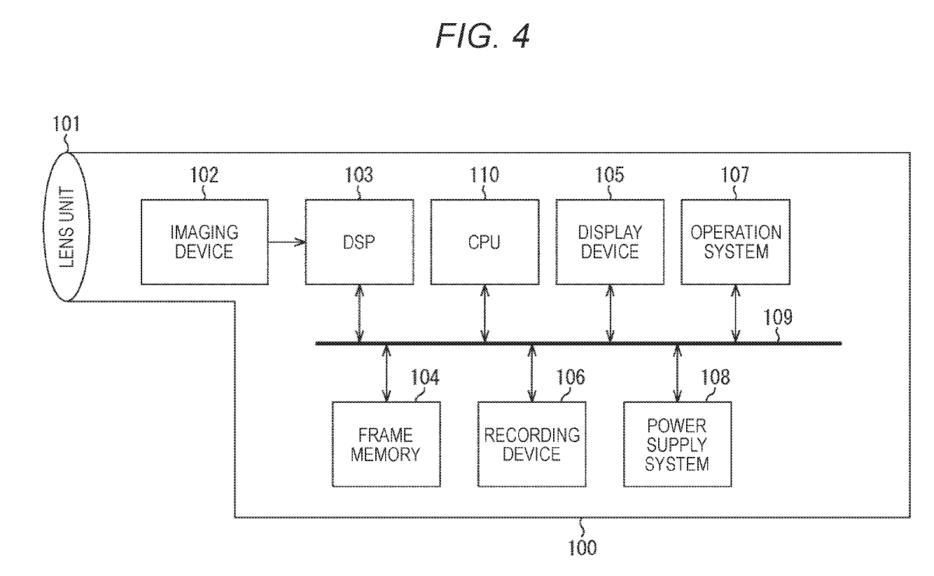

FIG. 4 is a block diagram illustrating one example of a configuration of an electronic device (e.g., imaging apparatus) according to the present technology. As shown in FIG. 4, an imaging apparatus 100 according to the present technology includes an optical system having a lens unit 101 and the like, an imaging device (imaging element) 102, a DSP circuit 103, a frame memory 104, a display device 105, a recording device 106, an operation system 107, a power supply system 108, and the like. In addition, the DSP circuit 103, the frame memory 104, the display device 105, the recording device 106, the operation system 107, and the power supply system 108 are connected to one another via a bus line 109.

The lens unit 101 receives incident light (image light) from an object, and focuses the light onto an imaging surface of the imaging device 102. The imaging device 102 converts a light intensity of the incident light focused on the imaging surface by the lens unit 101, into an electrical signal for each pixel, and outputs the electrical signal as a pixel signal.

The display device 105 includes a panel display device, such as a liquid crystal display device, an organic electroluminescence (EL) display device, or the like, and displays a video or still image imaged by the imaging device 102. The recording device 106 records the video or still image imaged by the imaging device 102 on a recording medium, such as a digital versatile disc (DVD), a hard disk drive (HDD), or the like.

The operation system 107 issues operation instructions on various functions of the imaging apparatus in response to user operation. The power supply system 108 supplies power for various applications to the DSP circuit 103, the frame memory 104, the display device 105, the recording device 106, and the operation system 107, as operation power therefor, as appropriate.

The imaging apparatus having the configuration described above can be used as an imaging apparatus, such as a video camera and a digital still camera, as well as a camera module for a mobile device, such as a mobile phone terminal. Besides, the imaging apparatus described above can be used as the imaging device 102 in the imaging apparatus.

### Example Application of Imaging Device

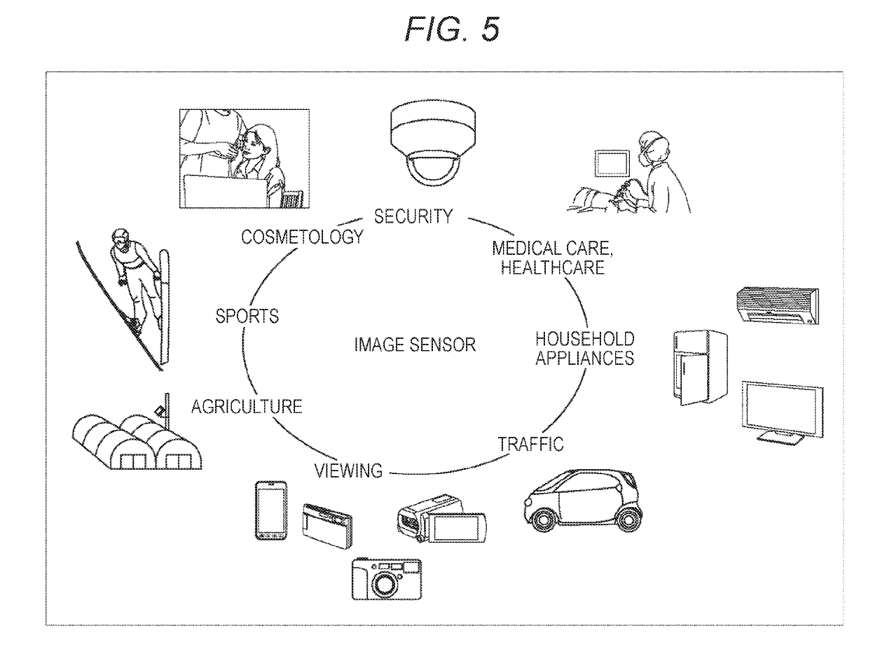

FIG. 5 is a diagram for illustrating example applications that employ the imaging apparatus described above or an electronic device including the imaging apparatus described above.

The imaging device described above is applicable to various cases, for example, of sensing light such as visible light, infrared light, ultraviolet light, an X-ray, and/or the like as described below.

An apparatus for capturing an image for viewing, such as a digital camera and a mobile device having a camera function;

an apparatus for use in traffic applications, such as an in-vehicle sensor for imaging the front, back, periphery, interior, and the like of an automobile for safe driving, including automatic stop, for recognizing the condition of a driver and the like; a surveillance camera for monitoring moving vehicles and/or the road; a distance measurement sensor for measuring a distance such as an inter-vehicle distance;

an apparatus for use in a household appliance, such as a TV, a refrigerator, an air conditioner for imaging a user gesture for operating a device on the basis of the gesture;

an apparatus for use in medical or healthcare applications, such as an endoscope, an apparatus for imaging a blood vessel by receiving infrared light;

an apparatus for use in security applications, such as a surveillance camera for crime prevention purposes, a camera for personal authentication;

an apparatus for use in cosmetic applications, such as skin measurement device for imaging skin, a microscope for imaging a scalp;

an apparatus for use in sports, such as an action camera, a wearable camera for sports applications; and

an apparatus for use in agriculture, such as a camera for monitoring the field and/or the condition of crops

Note that the effects described in this specification are merely by way of example, and are not intended to be restrictive. In addition, other effects may also be provided.

Note that the embodiment of the present technology is not limited to the embodiment described above, and numerous modifications may be made without departing from the spirit of the present technology.

Note that the present technology can include the configurations described below.

(1)

An imaging apparatus including:
a substrate having an imaging device mounted thereon;
a frame fixed on the substrate; and
a seal glass,
in which the seal glass and the frame are bonded together using a sealing resin to provide a structure that encapsulates the imaging device.

(2)

The imaging apparatus according to (1), in which a cured material resulting from curing of the sealing resin has a regular reflectance of 3% or less.

(3)

The imaging apparatus according to (1) or (2), in which a cured material resulting from curing of the sealing resin has a diffuse reflectance of 30% or less.

(4)

The imaging apparatus according to (1) or (2), in which a cured material resulting from curing of the sealing resin has a diffuse reflectance of 10% or less.

(5)

The imaging apparatus according to any one of (1) to (4), in which a cured material resulting from curing of the sealing resin has a surface roughness of 0.5 um or more.

(6)

The imaging apparatus according to any one of (1) to (5), in which the sealing resin that bonds together the seal glass and the frame has a composition including a flat filler and a particulate filler.

(7)

The imaging apparatus according to (6), in which the flat filler is formed of one or a combination of talc, mica, and boron nitride (BN).

(8)

The imaging apparatus according to (6) or (7), in which the flat filler has an average particle size in a range of from 0.1 to 100 um.

(9)

The imaging apparatus according to (6) or (7), in which the flat filler has an average particle size in a range of from 1 to 10 um.

(10)

The imaging apparatus according to any one of (6) to (9), in which the particulate filler is formed of one or a combination of silica (SiO₂), alumina (Al₂O₃), aluminum nitride (AlN), titanium oxide (TiO₂), barium titanate (BaTiO₃), zirconia (ZrO₂), zinc oxide (ZnO), ITO, yttrium oxide (Y₂O₃), cerium oxide (CeO₂), tin oxide (SnO₂), and copper oxide (CuO).

(11)

The imaging apparatus according to any one of (6) to (10), in which the particulate filler has an average particle size in a range of from 0.001 to 1 um.

(12)

The imaging apparatus according to any one of (6) to (10), in which the particulate filler has an average particle size in a range of from 0.01 to 0.1 um.

(13)

The imaging apparatus according to any one of (1) to (12), in which the sealing resin is a thermosetting resin.

(14)

The imaging apparatus according to any one of (1) to (12), in which the sealing resin is a UV-curable resin.

(15)

The imaging apparatus according to any one of (1) to (14), in which the sealing resin contains a coloring agent.

(16)

The imaging apparatus according to any one of (1) to (14), in which the sealing resin contains a coloring agent that absorbs visible light.

(17)

The imaging apparatus according to any one of (1) to (14), in which the sealing resin contains carbon black as the coloring agent.

(18)

The imaging apparatus according to any one of (1) to (17), further including:
a unit including a lens, on the frame.

(19)

An electronic device including:
an imaging apparatus including
   a substrate having an imaging device mounted thereon,
   a frame fixed on the substrate, and
   a seal glass,
   in which the seal glass and the frame are bonded together using a sealing resin to provide a structure that encapsulates the imaging device, and
a signal processing unit configured to perform signal processing on a signal output from the imaging apparatus.

### REFERENCE SIGNS LIST

11 Upper unit
12 Lower unit
31 Substrate
32 Imaging device
33 Seal glass
34 Frame
41, 42, 43 Sealing resin
71 Fillet

1. An imaging apparatus comprising:
a substrate having an imaging device mounted thereon;
a frame fixed on the substrate; and
a seal glass,
wherein the seal glass and the frame are bonded together using a sealing resin to provide a structure that encapsulates the imaging device.

2. The imaging apparatus according to claim 1, wherein a cured material resulting from curing of the sealing resin has a regular reflectance of 3% or less.

3. The imaging apparatus according to claim 1, wherein a cured material resulting from curing of the sealing resin has a diffuse reflectance of 30% or less.

4. The imaging apparatus according to claim 1, wherein a cured material resulting from curing of the sealing resin has a diffuse reflectance of 10% or less.

5. The imaging apparatus according to claim 1, wherein a cured material resulting from curing of the sealing resin has a surface roughness of 0.5 um or more.

6. The imaging apparatus according to claim 1, wherein the sealing resin that bonds together the seal glass and the frame has a composition including a flat filler and a particulate filler.

7. The imaging apparatus according to claim 6, wherein the flat filler is formed of one or a combination of talc, mica, and boron nitride (BN).

8. The imaging apparatus according to claim 6, wherein the flat filler has an average particle size in a range of from 0.1 to 100 um.

9. The imaging apparatus according to claim 6, wherein the flat filler has an average particle size in a range of from 1 to 10 um.

10. The imaging apparatus according to claim 6, wherein the particulate filler is formed of one or a combination of silica (SiO₂), alumina (Al₂O₃), aluminum nitride (AlN), titanium oxide (TiO₂), barium titanate (BaTiO₃), zirconia (ZrO₂), zinc oxide (ZnO), ITO, yttrium oxide (Y₂O₃), cerium oxide (CeO₂), tin oxide (SnO₂), and copper oxide (CuO).

11. The imaging apparatus according to claim 6, wherein the particulate filler has an average particle size in a range of from 0.001 to 1 um.

12. The imaging apparatus according to claim 6, wherein the particulate filler has an average particle size in a range of from 0.01 to 0.1 um.

13. The imaging apparatus according to claim 1, wherein the sealing resin is a thermosetting resin.

14. The imaging apparatus according to claim 1, wherein the sealing resin is a UV-curable resin.

15. The imaging apparatus according to claim 1, wherein the sealing resin contains a coloring agent.

16. The imaging apparatus according to claim 1, wherein the sealing resin contains a coloring agent that absorbs visible light.

17. The imaging apparatus according to claim 1, wherein the sealing resin contains carbon black as the coloring agent.

18. The imaging apparatus according to claim 1, further comprising:
a unit including a lens, on the frame.

19. An electronic device comprising:
an imaging apparatus including
a substrate having an imaging device mounted thereon,
a frame fixed on the substrate, and
a seal glass,
wherein the seal glass and the frame are bonded together using a sealing resin to provide a structure that encapsulates the imaging device, and
a signal processing unit configured to perform signal processing on a signal output from the imaging apparatus.
